(19) United States
(12) Patent Application Publication
(10) Pub. No.: US 2025/0255445 A1
(43) Pub. Date: Aug. 14, 2025

(54) AUTOMATED VACUUM AND CHARGER SYSTEM AND METHOD

(71) Applicant: EyeVac, LLC, Austin, TX (US)

(72) Inventor: Terry G. Jones, Austin, TX (US)

(73) Assignee: EyeVac, LLC, Austin, TX (US)

(21) Appl. No.: 18/857,677

(22) PCT Filed: Apr. 19, 2023
(86) PCT No.: PCT/US2023/019122

§ 371 Date: Oct. 17, 2024

Related U.S. Application Data
(60) Provisional application No. 63/332,474, filed on Apr. 19, 2022.

(51) Int. Cl. A47L 9/28; A47L 9/00; H02J 7/00

(52) U.S. Cl. CPC A47L 9/2873; A47L 9/0063; A47L 9/2805; A47L 9/2852; H02J 7/0044; A47L 2201/022; A47L 2201/04

(57) ABSTRACT

A system for vacuuming and charging includes a vacuum, a battery of the vacuum, a circuit for controlling the vacuum, a sensor connected to the circuit for detecting movement, and a cradle for charging the battery when the vacuum is connected to the cradle. The vacuum is moveable from the cradel and operational via the battery.

### TECHNICAL FIELD

The invention generally relates to cleaning systems for home and commercial environment, and more particularly relates to a sensor automated vacuum and charger station, which sensor automated vacuum may be charged and moved from the charger within the environment to clean swept refuse.

### BACKGROUND

Swept refuse is conventionally pushed to a dust pan and the dust pan emptied in a trash can. Certain devices, such as the automated electronic vacuum of U.S. Pat. No. 7,357,872, provide efficiency and ease of vacuuming swept refuse. That automated electronic vacuum includes sensor that detects movement near an inlet of the vacuum. The vacuum turns on and pulls refuse swept in vicinity of the inlet, when the sensor detects movement near the inlet.

The automated electronic vacuums have conventionally been relatively stationary in placement. They have operated by electricity provided from an electric outlet connected by an electrical cord of the vacuum. Though the automated electronic vacuums have provided ease of use, it can be cumbersome to locate an electric outlet for cord connection when it is desired to place the vacuum in certain places.

Certain portable handheld vacuums have included batteries and been chargeable. This has allowed the portable handheld vacuums to be employed in a location remote from any electric outlet and without cord connection. These portable handheld vacuums have typically not had strong enough vacuum motor for use in a wider area without directly running the vacuum over particles to be vacuumed. Moreover, these portable handheld vacuums have primarily operated by on/off button or the like, and in any event have not sensed movement for operation. Further, use of these handheld vacuums has generally required the user to bend the body to locate the vacuum on the refuse.

It would therefore be a significant benefit and improvement in the art and technology to provide a sensor automated electronic vacuum that is battery operated and charged in a charging cradle. It would also be a significant benefit and improvement to move and reposition such sensor automated electronic vacuum away from the charging cradle. It would further be a significant benefit and improvement to provide a sufficiently strong vacuum motor, operable by sensor detection of movement, in a battery operated configuration.

### SUMMARY

An embodiment of the invention includes a system for vacuuming and charging. The system includes a vacuum, a battery of the vacuum, a circuit for controlling the vacuum, a sensor connected to the circuit for detecting movement, and a cradle for charging the battery when the vacuum is connected to the cradle. The vacuum is moveable from the cradle and operational via the battery.

Another embodiment of the invention is a method for vacuuming and charging. The method includes vacuuming by a vacuum in response to movement detected by a sensor and charging a battery of the vacuum via a cradle. The vacuum is removable from the cradle and operational by the battery.

### BRIEF DESCRIPTION OF THE DRAWINGS

The present invention is illustrated by way of example and not limitation in the accompanying figures, in which like references indicate similar elements, and in which:

FIG. 1 illustrates a front perspective view of a system for vacuuming and charging a battery for vacuuming, according to certain embodiments of the invention;

FIG. 2 illustrates a top and back perspective view of a system for vacuuming and charging a battery for vacuuming, according to certain embodiments of the invention;

FIG. 3 illustrates a top and front perspective view of a cradle of a system for vacuuming and charging a battery for vacuuming, according to certain embodiments of the invention;

FIG. 4 illustrates a circuit for vacuuming, according to certain embodiments of the invention;

FIG. 5 illustrates a table of operating states for vacuuming, according to certain embodiments of the invention;

FIG. 6 illustrates a circuit for a system for illustrates a table of operating states for vacuuming, according to certain embodiments of the invention.

### DETAILED DESCRIPTION

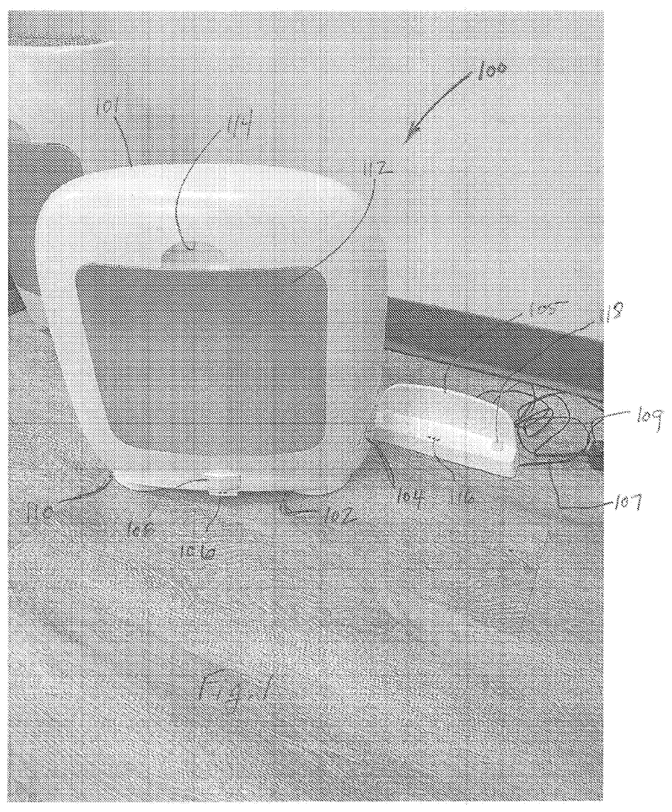

Referring to FIG. 1, a system 100 includes a housing 101. The housing 101 forms or connects to a vacuum air inlet 102 and a vacuum air outlet 104. A vacuum unit (not shown) contained in the housing 101 communicatively connects between the inlet 102 and the outlet 104.

The vacuum unit is powered by a battery (not shown) contained in or connected to the housing 101. The battery is chargeable via a cradle 105. The cradle 105 communicatively connects via a cord 107, which may also include a converter 109, to an AC electrical outlet, such as 110V or 220V or otherwise. The housing 101 includes conforming features to those of the cradle 105, such as in a base 110 of the housing 101. The housing 101 is connectable to the cradle 105, physically and communicatively, to charge the battery contained in the housing 101 for powering the vacuum unit.

The system 100 also includes a sensor 106. The sensor 106 is positioned near the inlet 102, and contained by or connected to the housing 101. The sensor 106 is communicatively connected (through circuitry as later described) to the vacuum unit. The sensor 106 detects any movement in vicinity of the sensor 106, such as refuse or debris and/or sweep of these. On detection of movement by the sensor 106, the vacuum unit may be turned on to vacuum pull refuse into the housing 101 and may, according to certain nonexclusive embodiments, cycle to off or otherwise automatically turn off as implemented.

The housing 101 includes a bin 112 or an access panel to the bin 112. The bin 112 or access panel, as applicable, may be opened via a notch 114 and manual tilt of the bin 112 with respect to the housing 101. Refuse vacuumed by the system 100 deposits in the bin 112. When the bin 112 is filled, it may be emptied on removal from the housing 101.

The cradle 105 may, for nonexclusive example, include contact elements 116 and guides 118. The base 110 is formed at a backside of the housing 101 with conforming structures to the cradle 105, such that the inlet 102 is located on or adjacent an underlying floor or surface when the base 110 is connected to the cradle. This allows the inlet 102 to operate for vacuuming when the housing 101 is connected to the cradle 105 for charging of a battery (not shown) contained in or connected to the housing 101. The battery powers the vacuum unit when turned on.

For non-exclusive example, the base 110 includes mating contact elements (not shown in detail) and mating guide receptors (not shown in detail). The guides 118 and mating guide receptors connect to retain the base 110 of the housing 101 to the cradle 105, in manner that the housing 101 is removable from the cradle 105. When the base 110 is retained to the cradle 105, the contact elements 116 and mating contact elements communicatively connect for charging of the battery of the housing 101 communicatively connected to the vacuum unit.

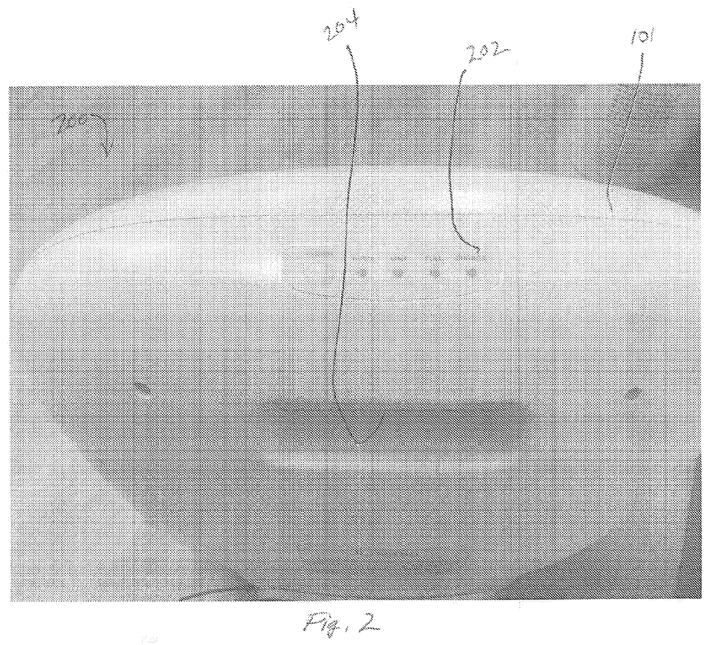

Referring to FIG. 2, in conjunction with FIG. 1, a system 200, such as the system 100, includes a control panel 202 connected to or included in the housing 101. The housing 101 also includes a backside handle 204, for nonexclusive example, an indentation in the housing 101 sufficient for hand grasp. For nonexclusive example, the control panel 202 may include a power button, an auto button, a manual button, a full bin indicator light, and a charging light.

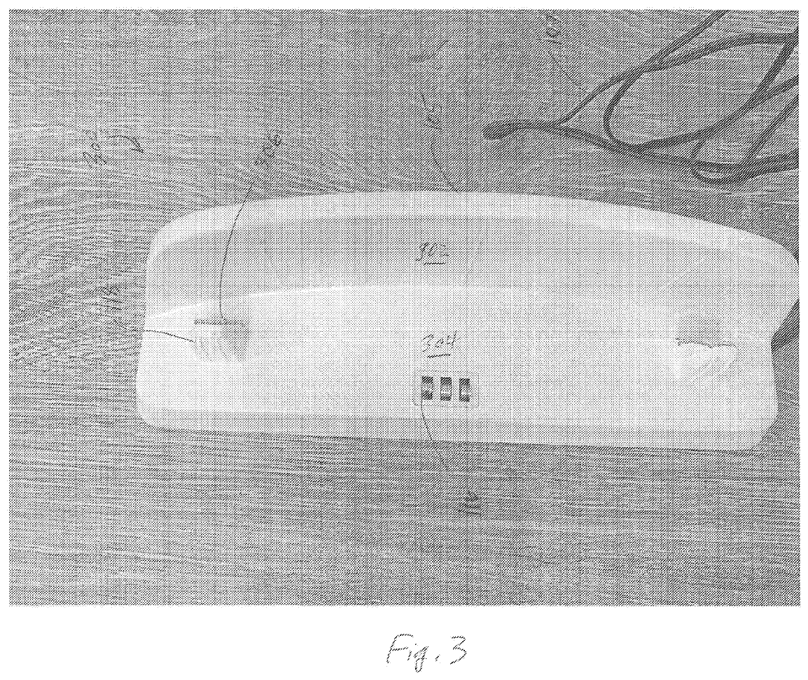

Referring to FIG. 3, in conjunction with FIGS. 1-2, a system 300 includes the cradle 105. The cradle 105 may include a back portion 302 perpendicular to a bottom portion 304. The bottom portion 304 may include, contain or form features for containing and presenting the contact elements 116 and projecting the guides 118. The cord 107 (shown in part) communicatively connects to the contact elements 116 of the cradle 105. The guides 118, for nonexclusive example, may include click pieces 306 for engaging the base 110 of the housing 101 when placed in the cradle 105 and releasing the base 110 from the cradle 105 when the housing 101 is grasped by the backside handle 204 and lifted from the cradle 105.

In operation, the systems 100, 200, 300 vacuum debris swept in vicinity of the inlet of the housing. The cradle, when the base of the housing is connected to it, charges a battery of the vacuum. The vacuum may be operated to on by button of the control panel or button near the inlet. The vacuum may also be automatically triggered on if the control panel setting is set to auto and movement is detected by the sensor. The vacuum may cycle off or otherwise automatedly turn off according to implementation. The vacuum may be moved from the cradle and operates for vacuuming, when the battery has been charged. The vacuum may therefore be moved about an environment and away from the cradle, in order to vacuum areas of an environment including where no electrical outlet is readily accessible.

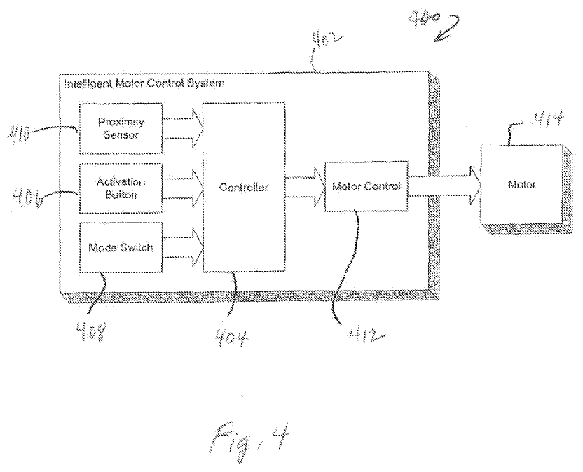

Referring to FIG. 4, a system 400 of a vacuum includes a circuit 402. The circuit 402 includes a controller 404. The controller 404 is communicatively connected to an activation button 406 to turn power on the system 400. A mode switch 408 is also communicatively connected to the controller 404. The mode switch 408 may be, for nonexclusive example, one or more button to set the operation of the system 400 in an auto mode, a manual mode, or otherwise according to the embodiment. The controller 404 is also communicatively connected to a sensor 410. The sensor 410, for nonexclusive example, detects movement in vicinity of a sensing element, such as a movement sensor, infrared sensor, or other. A motor control 412 is communicatively connected to the controller 404. The motor control 412 operates a vacuum motor 414 communicatively connected to the motor control 412.

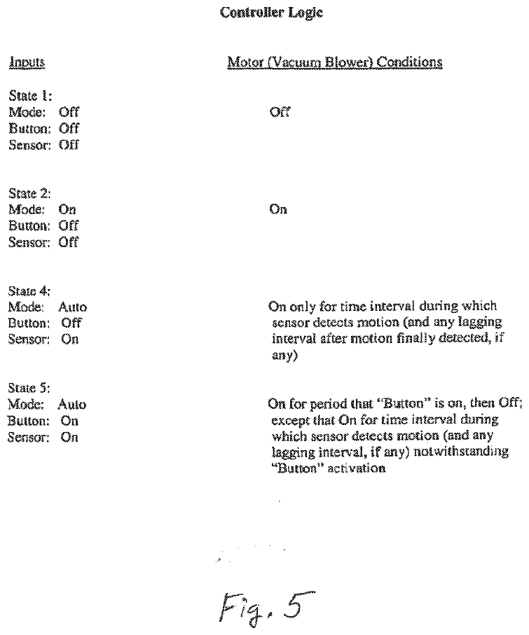

Referring to FIG. 5, in conjunction with FIG. 4, various states for logical operations of the controller 404 are shown in the table. In effect, the controller 404, based on the inputs of the activation button 406, the mode switch 408 and the sensor 410, dictates operations of the motor control 412 to physically control the vacuum motor 414 either on or off. As listed in the table, the vacuum motor 414 is “on”, if and when either: (i) the Mode is set to On via manual input by a human user; or (ii) the Sensor is set to On by detection of an event (such as movement in vicinity of a vacuum inlet) when the Mode is set to “auto” via manual input by a human user. In other states, the vacuum motor 414 is controlled off (e.g., is not supplied with power) via the logic of the controller 404 and its handling of the motor 414 through the motor controller 412, for nonexclusive example, the controller 404 and/or the motor controller 412 may provide a cycle off timing or other automated turn off implementation.

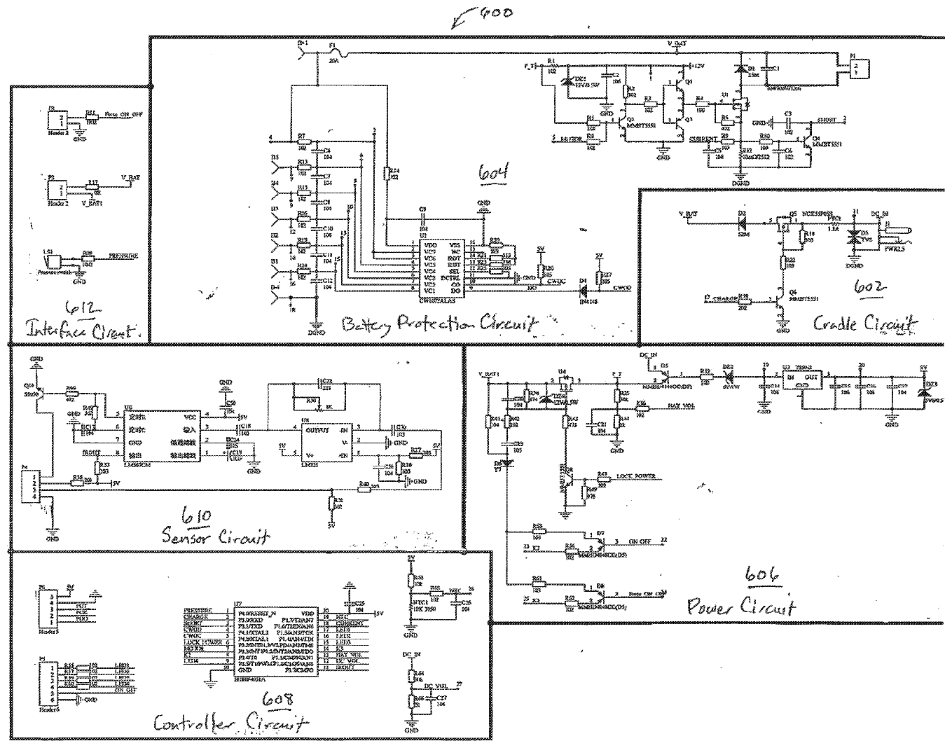

Referring to FIG. 6, a system 600 for charging and vacuuming includes a cradle circuit 602. The cradle circuit 602 is communicatively connected to a battery protection circuit 604 when a battery powered vacuum is connected to a charging cradle. The battery protection circuit 604 is communicatively connected in the vacuum to a power circuit 606. The power circuit 606 is communicatively connected in the vacuum to a controller circuit 608. The controller circuit 608 is communicatively connected in the vacuum to a sensor circuit 610. An interface circuit 612 of the vacuum is communicatively connected to the controller circuit 608.

Additional, different, or other output devices, input devices, controllers, power sources, and other devices, as well as additional, different or other circuits and connections are possible.

As will be understood, wide variation is possible in the foregoing embodiments. Various arrangements of cradle and charging elements of the vacuum are possible. Also, the vacuum unit can be any type of vacuum device and can include all possible vacuum technologies. Non-exclusive embodiments include unitized features of the system, as well as component options. For example, the vacuum can be contained in a single housing, and parts or all of the respective elements and units may be detachable, such as for cleaning, repair and otherwise. Although housing of the unit is illustrated as standalone, cradleable, and moveable from the cradle, the vacuum and cradle can be integrated into or with other devices or systems. Variation is also possible in the operations of the vacuum. Although certain operations and elements for operation are disclosed, numerous other steps, operations, processes and methods, as well as other and similar elements, may be implemented in the systems.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system, comprising:
a vacuum;
a battery of the vacuum;
a circuit for controlling the vacuum;
a sensor connected to the circuit for detecting movement; and
a cradle for charging the battery when the vacuum is connected to the cradle;
wherein the vacuum is moveable from the cradle and operational via the battery.

2. A method, comprising:
vacuuming by a vacuum in response to movement detected by a sensor; and
charging a battery of the vacuum via a cradle;
wherein the vacuum is removable from the cradle and operational by the battery.
